(19) United States
(12) Patent Application Publication
(10) Pub. No.: US 2022/0024061 A1
(43) Pub. Date: Jan. 27, 2022

(54) INFLATABLE RAZOR

(71) Applicant: BIC VIOLEX S.A., Anoixi (GR)

(72) Inventors: Efstratios CHRISTOFIDELLIS, Anoixi (GR); Nikolaos OVVADIAS, Anoixi (GR); Vasileios STAMOULIS, Anoixi (GR)

(73) Assignee: BIC VIOLEX S.A., Anoixi (GR)

(21) Appl. No.: 17/296,865

(22) PCT Filed: Dec. 18, 2019
(86) PCT No.: PCT/EP2019/086051

§ 371 Date: May 25, 2021

(30) Foreign Application Priority Data
Dec. 19, 2018 (EP) 18214195.2

(51) Int. Cl. B26B 21/52

(52) U.S. Cl. CPC B26B 21/522

(57) ABSTRACT

This application relates to a handle. The handle may comprise a chamber. The chamber may be inflatable. The handle may be configured to pass from a first state to a second state. The handle may be configured to pass between these states in response to a volumetric change of the chamber. The handle may cooperate with a stand. The handle may be for a handheld device. The handheld device may be a hygiene device. The hygiene device may be a skincare device. The skincare device may be a shaver. The shaver may comprise one or more blades for cutting hair. The shaver may be a razor. The handle and/or the stand may be provided in a kit, a skincare kit, or even a shaving kit.

This application is a National Stage Application of International Application PCT/EP2019/086051, filed on 18 Dec. 2019, now published as WO2020127554. This application claims priority to European patent application EP18214195.2 filed on 19 Dec. 2018, the entire content of which are incorporated herein by reference. The present description relates to the field of skincare, and in particular to shaving. More specifically, the present description relates to a handheld skincare device, a handle therefor, and a skincare kit or shaving kit including such a handle.

### FIELD

### Background

Suboptimal ergonomy has repercussions not only in terms of the comfort of use of a skincare device, but also for safety. For example, discomfort can increase or even be a symptom of fatigue and may increase the risk of potentially ineffective or even unsafe maneuvering of the skincare device.

To reduce the adverse effects of ineffective or unsafe manipulation of a razor, the document U.S. Pat. No. 2,235,841A discloses an elastic handle for safety razors.

The arrangement described may not allow a user shave more comfortably.

### SUMMARY

It has been found that handle girth plays a key role in the ergonomics, safety, comfort, and ease-of-use of skincare devices, and that a need to provide a handle that offers a desirable girth for a wide variety of hand sizes exists.

A problem in the shaving field is that the ergonomic benefits provided by any given handle of razor are highly dependent on the size of the hand of the user manipulating the device. For example, if a user's hand is larger than the hand for which the handle was designed, then manipulation of the razor with this hand may be uncomfortable for the user. Likewise, if the user's hand is smaller than the hand for which the handle was designed, then manipulation of the razor with this hand may be uncomfortable for the user.

According to embodiments of the present disclosure, a handle is provided. The handle is for a device. The device is a skincare device. The handle includes a chamber. The chamber is inflatable. The handle is configured to pass from a first state to a second state. The handle is configured to pass between these states in response to a volumetric change of the chamber.

Passing from the first state to the second state provides for a girth and/or a volume of the handle to be changed in order to be greater in the second state than in the first state. For example, if the handle presents a first girth in the first state, and a second girth in the second state, then passing the handle from the first state to the second state can allow the handle's girth to be varied between the first girth and the second girth. This means that the overall shape or size of the handle changes thereby rendering a more versatile handle or a handle fitting different hand sizes can thus be provided. Put in other words, a “one handle fits all” handle can be provided.

The chamber can provide for a space through which the handle may pass between the first and second states. A chamber that is inflatable may change in volume in response to a change in the relationship between absolute pressure inside the chamber and absolute pressure outside the chamber. A chamber that is inflatable can serve to guide the handle as it moves between the first and second states. For example, inflation or deflation of the chamber can cause the handle to enter or leave one of the first or second states. If the handle passes from the first state to the second state in response to a volumetric change of the chamber, then it can be possible to control the state of the handle by controlling the volume of the chamber.

In aspects, the handle includes a support. The support is connected to the chamber.

The support may form at least a portion of the handle's overall shape and/or structure. If the support is connected to the chamber, the support may facilitate volume changes in the chamber occurring in one direction, and the support may discourage volume changes in the chamber occurring in some other direction. For example, the support may locally inhibit movement of the chamber in a connection region of the chamber, but may locally permit movement of the chamber in other regions of the chamber.

In aspects, the handle may include a button. The support may include the button. The button may be a fluid-release button. The fluid may be air.

The button may allow a user to control a change in a state of the handle. For example, the button may allow a user to control a change in volume of the chamber. If the button is a fluid-release button, the button may allow a user to control whether the fluid is retained in the chamber and/or released from the chamber. Additionally or alternatively, such a button may allow a user to control how quickly fluid is released from the chamber. A user may thereby be able to change a girth of the handle without connecting the handle to a pump.

In aspects, a girth and/or a volume of the handle in the second state may be greater than a girth and/or a volume of the handle in the first state.

As such, the handle may be made to expand or shrink as it changes between the first and second states.

In aspects, at least a portion of the support may be more rigid than at least a portion of the chamber. In this way, this portion of the chamber may undergo a larger deformation than the at least a portion of the support during passage of the handle between the first and second states.

For example, the chamber may include a first material. The support may include a second material. The second material may have a hardness greater than the first material. The hardness may be measured by Shore hardness or Shore durometer, more specifically Shore durometer type A. Selection of materials of different hardness values may allow the rigidity relationship between the portions of the support and the chamber to be fine-tuned.

Additionally or alternatively, the relationship in rigidity between the support and the chamber may be fine-tuned through differences in these components' local geometries. For example, the portion of the chamber may be made thinner than the portion of the support.

The support is arranged on two or more external portions of the chamber. The two or more external portions of the chamber may be contiguous with one another or non-contiguous with one another.

In this way, at least a portion of a user's hand(s) and/or finger(s) can be brought to bear on a portion of the handle which may offer relative rigidity and/or relative stability. Such an arrangement may facilitate manipulation of the handle, as well as maneuvering of an object connected thereto.

In aspects, the support may include a central body. The support may include at least one peripheral body, and more specifically two or more peripheral bodies. The peripheral body/bodies may be moveable relative to the central body.

The central body may provide structure to at least an end portion of the handle. The peripheral body/bodies may provide structure to at least a lateral portion of the handle. The peripheral body/bodies may provide an external surface on which a portion of a user's finger(s) and/or hand(s) can be brought to bear. Movability of a peripheral body relative to the central body may thus allow the chamber to change in volume even if the peripheral body is arranged on an external portion of the chamber.

In aspects, at least one peripheral body supports a gripping feature.

The gripping feature may increase friction between the handle and a user's finger(s) and/or hand(s), relative to a handle that lacks a gripping feature. The gripping feature may include one or more projections. The gripping feature may include a texture. The gripping feature may include a rubber layer arranged on an external surface of the peripheral body.

In aspects, at least one peripheral body may be formed as a lobe. The lobe may have a proximal end connected to the central body.

As such, this peripheral body may move with respect to the central body about the connection between the central body and the peripheral end of the lobe. This movement may be in the form of a relative rotation between the central body and at least a portion of the lobe.

In aspects, at least one peripheral body may be formed as a shell. The shell may be separated from the central body.

As such, local mobility of this peripheral body is not necessarily determined by proximity to the central body. Alternatively, connectors, e.g. in the form of connector rods, may be provided between the shells to ensure the separation between them is maintained, e.g. when the chamber is inflated/expanded.

In aspects, at least two or more of the peripheral bodies may be connected to one another to form a wrap.

In aspects, at least a portion of the handle may be configured to expand from the first state to the second state in a direction oblique or perpendicular to a longitudinal axis of the handle.

In this way, moving from the first state to the second state increases the girth of the handle. Moving from the second state to the first state decreases the girth of the handle. Movement in a direction oblique or perpendicular to a longitudinal axis of the handle can be understood to include rotation about an axis that is oblique or perpendicular to the longitudinal axis, as well as translation in a direction that is oblique or perpendicular to the longitudinal axis.

In aspects, the longitudinal axis may run along a length of the handle and be curvilinear.

In aspects, the handle may include a port. The port may be for changing a volume of the chamber, or more specifically a volume inside the chamber. The port may be for introducing a fluid into the chamber, and/or removing a fluid from the chamber. In other words, the port may have a single functionality, or a double or other multiple functionality.

In this way, the volume of the chamber may be changed by introducing fluid into the chamber and/or by removing fluid from the chamber through the port. Removal of fluid from the chamber may be performed actively or passively. As a non-limiting example, fluid may be removed passively by exhausting it from the chamber. As a non-limiting example, the fluid may include a liquid and/or a gas. As a non-limiting example, the liquid may include water, oil, or any liquid that is compatible with the chamber. As a non-limiting example, the gas may include nitrogen, carbon dioxide, air, or any gas that is compatible with the chamber.

In aspects, the port may be provided in a bearing surface. The bearing surface may facilitates cooperation of the stand and the handle by aiding in proper alignment and connection therebetween.

In aspects, the port may be removably connectable to a stand.

The stand may include a pump which may provide fluid to be introduced into the chamber and/or extract fluid contained in the chamber. When a change in volume of the chamber is desired, a user may connect the handle to the stand to change the chamber's volume. By disconnecting the stand from the handle, a user may, for example, reduce the weight of the handle. Reducing the weight of the handle may further contribute to improve maneuverability and/or facilitate manipulation.

According to further embodiments of the disclosure, a pump may be provided. The pump may be for a handle. The handle may be a handle as described earlier herein, although the features of the pump may be completely independent of the features of the handle. The pump may be connected to a nozzle. The nozzle may be adapted to at least partially inflate the chamber. Additionally or alternatively, the nozzle may be adapted to at least partially deflate the chamber. The nozzle may be disposed in a stand. The stand may be configured to support the handle. In examples, the stand may include the pump.

The pump may be any equipment that is used to cause a fluid to move from one place to another. Non-limiting examples of such equipment include positive displacement pumps, impulse pumps, velocity pumps, gravity pumps, valveless pumps, etc. The pump described above may well include any number or type of such equipment. Moreover, the term “pump” as used hereafter may also be understood to encompass any device capable of delivering fluid to the handle and/or extracting fluid from the handle. For example, the pump may lack any of the abovementioned equipment and instead include a connection to a source of pressurized fluid, such as a tap. Alternatively, such equipment may be used in combination with such a connection.

The nozzle may be adapted to connect to the port of the handle. Such an arrangement may allow fluid delivered by the nozzle to be introduced into the chamber via the port. Additionally or alternatively, this arrangement may allow the pump to extract fluid from the chamber by removing it through the port. By at least partially inflating the chamber, and/or partially deflating the chamber, the nozzle may allow the handle to pass between the first and second states.

The stand may provide a stable position for the handle during connection to the pump. The stand may provide a way to resist disconnection of the handle from the nozzle during delivery of fluid to the handle and/or extraction of fluid from the handle. If the nozzle is disposed in the stand, a user may be able to let go of the handle (rather than holding the handle in hand) when the handle is connected to the pump.

According to further embodiments of the disclosure, a handheld device may be provided. The handheld device may include a handle as described earlier herein, although the features of the handheld device may be completely independent of the features of the handle. The handheld device may be a handheld skincare device. The handheld skincare device may include one or more blades for cutting hair.

The handle may allow the ergonomics of the handheld device to be customized to a user's hand substantially as explained herein. Non-limiting examples of handheld devices include handheld tools, handheld sporting equipment, handheld writing devices, massage devices, and hygiene devices. Non-limiting examples of hygiene devices include oral hygiene devices, e.g. toothbrushes, and skincare devices. Non-limiting examples of skincare devices include exfoliators and/or hair-removal devices. Non-limiting examples of hair-removal devices include epilators and shavers (electric or non-electric). A shaver may be understood to be a handheld skincare device having one or more blades for cutting hair. A shaver may be a razor.

The presence of the above-described handle in a device may allow a user to enjoy a customized ergonomy during use of the device. Likewise, the presence of the above-described handle in a shaver may allow a user to enjoy customized ergonomy during hair removal. As such, the user may find use of the skincare device to be more comfortable than use of a skincare device with a handle that is too large or too small for the user's hand(s).

According to further embodiments of the disclosure, a kit may be provided. The kit may include a handle. The handle may be a handle as described earlier herein. The kit may kit may include a stand. The stand may include a pump. The pump may be a pump as disclosed earlier herein. The pump may be for a handle, more specifically the pump may be for a handle as described earlier herein. The kit may include a control panel. The control panel may be configured to select an on-off condition for the pump. The kit may be a skincare kit. The skincare kit may include a skincare device. The skincare device may be a skincare device as described earlier herein. The skincare kit may be a shaving kit. The shaving kit may include a hair removal device. The hair removal device may be a hair removal device as described earlier herein. The hair removal device may be a shaver. The shaver may be a shaver as described earlier herein.

The control panel may allow a user to control the pump. For example, a user may adjust one or more settings related to operation of the pump. One such setting may be an on-off condition. The on-off condition may, for example, be pressure and/or volume. More specifically, the on-off condition may be the pressure at the nozzle and/or within the chamber, and/or even the volume of the chamber, and/or a volume of fluid moved from one place to another by the pump, and/or a duration in which fluid is able to be delivered to/extracted from the handle.

The control panel may be provided in the handle. The control panel may be provided in the stand. The control panel may be provided as a separate entity, such as a user interface on a computing device or communication terminal.

### BRIEF DESCRIPTION OF THE DRAWINGS

The disclosure may be more completely understood in consideration of the following detailed description of aspects of the disclosure in connection with the accompanying drawings, in which:

FIGS. 1A-1B show an exemplary handle component.

FIG. 2 shows an exemplary handle.

FIGS. 3A-3C show an exemplary skincare device and an exemplary stand.

FIG. 4 shows an exemplary skincare device.

FIGS. 5A-5B show an exemplary skincare device.

While aspects of the disclosure are amenable to various modifications and alternative forms, specifics thereof have been shown by way of example in the drawings and will be described in detail. It should be understood, however, that the intention is not to limit aspects of the disclosure to the particular embodiment(s) described. On the contrary, the intention of this disclosure is to cover all modifications, equivalents, and alternatives falling within the scope of the disclosure.

### DETAILED DESCRIPTION

As used in this disclosure and the appended claims, the singular forms “a”, “an”, and “the” include plural referents unless the content clearly dictates otherwise. As used in this disclosure and the appended claims, the term “or” is generally employed in its sense including “and/or” unless the content clearly dictates otherwise.

The following detailed description should be read with reference to the drawings. The detailed description and the drawings, which are not necessarily to scale, depict illustrative aspects and are not intended to limit the scope of the disclosure. The illustrative aspects depicted are intended only as exemplary.

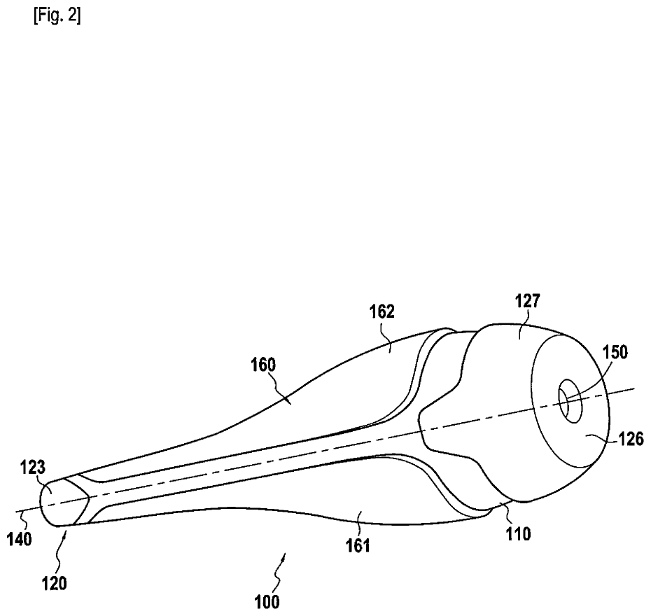

FIG. 2 shows an exemplary handle 100 as described herein. The handle 100 includes a chamber 110. The chamber 110 is inflatable and is related to the handle in such a manner that changing the volume of the chamber 110 causes the handle 100 to pass from a first state to a second state in response to a volumetric change of the chamber 110. The second state may thus encompass a greater handle girth and the first state a lower handle girth. Put in other words, in the second state an overall size or shape of the handle is bigger than in the first state.

The chamber 110 is an inflatable chamber. In such an arrangement, inflation of the chamber 110 causes the volume of the chamber 110 to increase by way of expansion thereof, and/or deflation of the chamber 110 causes the volume of the chamber 110 to decrease by way of contraction thereof. The chamber 110 may be at least partially exposed (e.g. having exterior surfaces).

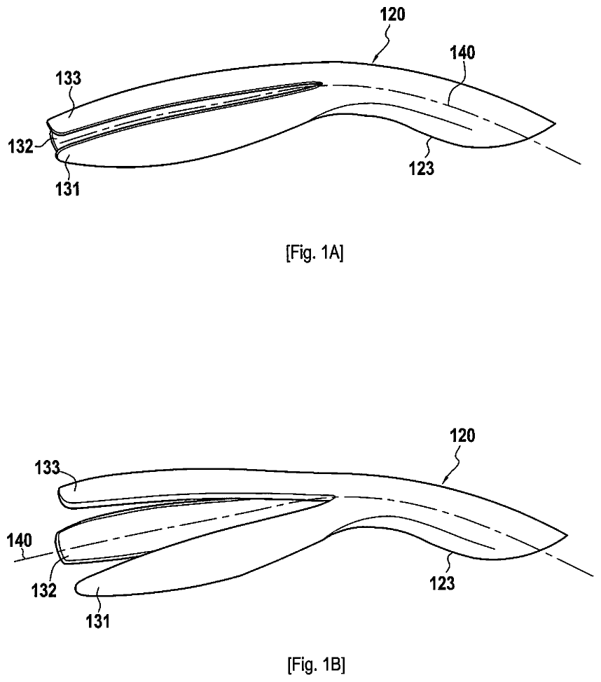

The handle 100 may present a central axis 140 running along a length of the handle 100. This axis 140 may be curvilinear, as in the examples shown in FIGS. 1A-1B, or the axis 140 may be straight, as shown in FIG. 2, for example.

The chamber 110 is connected to a support 120. The chamber 110 may be arranged between the axis 140 and the support 120. Such an arrangement will be referred to as “exoskeletal”, and will be discussed in greater detail with regard to FIGS. 1A-1B & 2.

In contrast, if the support 120 is arranged between the axis 140 and an internal surface of the chamber 110, the arrangement will be referred to as “endoskeletal”. A support 120 suitable for an endoskeletal arrangement will be discussed in detail later with regard to FIGS. 1A-1B.

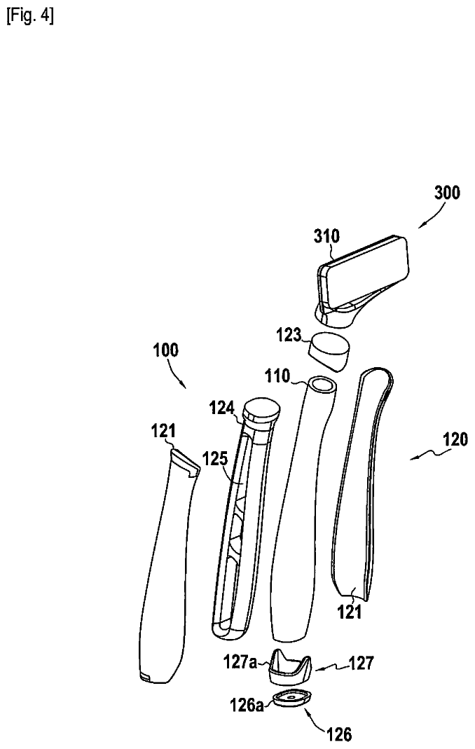

A handle 100 may include a support 120 that includes both an endoskeletal arrangement and an exoskeletal arrangement. Such an arrangement will be referred to as “hybrid”, and will be discussed in greater detail with regard to FIG. 4.

During changes in girth of the handle 100, at least one element of the support 120 may undergo less deformation than at least one portion of the chamber 110. This may be accomplished, for example, when at least a portion of the chamber 110 is less rigid than at least a portion of the support 120.

Such a rigidity relationship may be obtained for example, if the chamber 110 includes a first material, and the support 120 includes a second material which is harder than the first material. For example, the chamber 110 may include an elastomeric material. For example, the elastomeric material may include a rubber material, and/or a compressible elastomeric material, such as a thermoplastic rubber, such as, for example, Santoprene™ that was trademarked in 1977 by Monsanto. The support 120 may include a plastic material, for example a moldable non-elastomeric material, such as polypropylene or acrylonitrile butadiene styrene (ABS) resin.

Hardness of the first and/or second material may be measured using shore durometer type A, for example.

Non-limiting examples of the geometry of chamber 110 include fixed-length (FIG. 4) and variable-length (FIG. 2). A fixed-length chamber 110 may have one dimension (the “length”) which remains substantially constant as the chamber 110 undergoes changes in volume (e.g. expansion/contraction). A variable-length chamber 110 may be capable of expanding/contracting along the central axis 140 of the handle 110 during changes in volume, as well as or instead of expanding/contracting at least a portion of the handle in a direction oblique or perpendicular to the central axis 140.

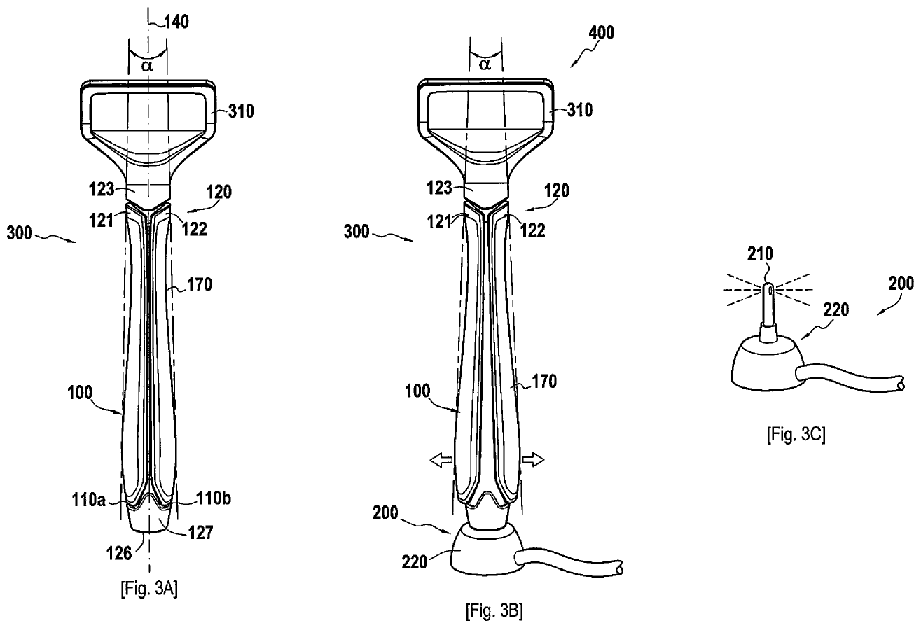

A chamber 110 may be simple (as seen in FIGS. 2 & 4) or branched (as seen in FIGS. 3A-3B). A chamber 110 may be considered branched when two external surfaces of the chamber face one another, or when internal structures such as membranes divide the chamber 110 into multiple plena. A branched chamber 110 may have a fixed length (as seen in FIGS. 3A-3B) or may be of variable length. Moreover, a branched chamber may include a branch which has a fixed length, combined with a branch which has a variable length.

As seen in FIG. 2, the support 120 may be arranged on an external surface of the chamber 110. This is an example of an “exoskeletal” support. Arrangement of the support 120 on an external surface of the chamber 110 may allow the support 120 to move with the external surface of the chamber 110 as the chamber 110 undergoes changes in volume.

Although not shown in the Figures, other possible arrangements for the support 120 may qualify as exoskeletal. For example, instead of being in contact with an external surface of the chamber 110, the support 120 may provide a section of the chamber 110 itself. In other words, two portions of the chamber 110 may be formed of the second material (i.e. the material of the support 120), and these two portions of the chamber 110 are then linked to each other by way of a portion of the chamber 110 formed of the first material.

In contrast to an exoskeletal arrangement, an endoskeletal arrangement features a portion of the support 120 which is arranged between an interior surface of the chamber 110 and the central axis 140 of the handle. The support 120 shown in FIGS. 1A-1B may be suitable for such an arrangement, for example, by surrounding the support 120 with the chamber.

Alternatively, the support 120 shown in FIGS. 1A-1B may be suitable for being arranged on the external surface of the chamber 110. In this regard, the support 120 may be suitable for use in an exoskeletal and/or hybrid arrangement.

In FIG. 4, a handle 100 is presented in an exploded view. The support 120 contains portions which are arranged on external surfaces of the chamber 110, as well as a frame 124. The frame 124 may be arranged within the chamber 110 when the handle 100 is assembled. The frame 124 may provide rigidity to the overall handle 100 while allowing the chamber 110 to expand and/or contract.

The frame 124 may include one or more holes 125. These holes 125 may reduce weight of the frame 124 and/or material usage to manufacture the frame 124. The holes 125 may alternatively or additionally facilitate movement and/or distribution of fluid within the chamber 110.

As the handle 100 changes between the low girth state and the high girth state, at least a portion of the handle 100 may move in a direction that is oblique or perpendicular to the longitudinal axis 140. This portion of the handle may be a portion of the support 120, for example.

Regardless of the type of support 120 (exoskeletal, endoskeletal, or hybrid) used in the handle 100, expansion or contraction of the chamber 110 may cause at least a portion of the support 120 to move in a direction that is oblique or perpendicular to the central axis 140 of the handle 100. Non-limiting examples of the movement of the(se) portion(s) of the support 120 can be seen in FIGS. 1A-1B & 3A-3B.

In FIGS. 1A-1B, it can be seen that the movement of a portion of the support 120 in a direction oblique or perpendicular to the central axis 140 of the handle 100 may include a rotation. More specifically, the rotation may be about an axis that is oblique or perpendicular to the central axis 140. For example, different portions of the support may rotate about different axes all being oblique or perpendicular to the handle central axis.

The examples of FIGS. 3A-3B show that the movement of a portion of the support 120 in a direction oblique or perpendicular to the central axis 140 of the handle 100 may include a translation. More specifically, the translation may be in a direction that is oblique or perpendicular to the central axis 140.

FIGS. 1A-1B, 2, 3A-3B, 4 & 5A-5B, show that at least a portion of the support 120 is arranged on two or more external portions of the chamber 110. This may allow a user to bring the hand(s) and/or finger(s) to bear on portions of the handle 100 where the support 120 is located.

In FIGS. 1A-1B, 2, 3A-3B, 4 & 5A-5B the support 120 is shown as including a central body 123 and two or more peripheral bodies 121, 122, 131, 132, 133, 161, 162. The peripheral bodies 121, 122, 131, 132, 133, 161, 162 may be formed as lobes 131, 132, 133, or as shells 121, 122. Moreover, the peripheral bodies may be formed as a wrap 160.

The peripheral bodies 121, 122, 131, 132, 133, 161, 162 may rest on an external surface of the chamber 110. As such, a change in volume of the chamber may cause sliding between the external surface of the chamber and the peripheral body 121, 122, 131, 132, 133, 161, 162. Alternatively, if two peripheral bodies 121, 122, 131, 132, 133, 161, 162 are connected to one another by the first material (i.e. the material of the chamber 110) then a change in volume of the chamber may cause extension and/or retraction of the first material between the peripheral bodies 121, 122, 131, 132, 133, 161, 162.

At least one of the peripheral bodies 121, 122, 131, 132, 133, 161, 162 may have a concave inner surface disposed towards the central axis 140 of the handle 100. If the peripheral body 121, 122, 131, 132, 133, 161, 162 rests on an external surface of the chamber 110, a concave inner surface may improve stability of the peripheral body 121, 122, 131, 132, 133, 161, 162 on the chamber 110.

At least one of the peripheral bodies 121, 122, 131, 132, 133, 161, 162 may have a convex outer surface disposed away from the central axis 140 of the handle 100. A convex outer surface may improve comfort when the handle 100 is held in a user's hand.

In FIGS. 1A-1B, a support 120 can be seen in which the peripheral bodies 131, 132, 133 are lobes. As the handle 100 changes between a low girth state and a high girth state, so does the support 120. For example, in FIG. 1A, the support 120 is shown in a state corresponding to a first girth state of the handle 100 (e.g. a low girth state), and in FIG. 1B, the support 120 is shown in a second girth state of the handle 100 (e.g. a high girth state). As the support 120 transitions between these states, the peripheral bodies 131, 132, 133 deform. As a peripheral body 131, 132, 133 in the form of a lobe deforms, a portion of the peripheral body 131, 132, 133 rotates about an axis that is oblique or perpendicular to the central axis 140 of the handle 100. This rotation causes this portion of the peripheral body 131, 132, 133 to move in a direction that is oblique or perpendicular to the central axis 140. This movement causes the support 120 to undergo a change in girth as the peripheral bodies 131, 132, 133 approach or spread out from one another.

To facilitate the movement of the peripheral bodies 131, 132, 133 formed as lobes, at least one lobe may include a flexible region which bends as the lobe(s) deform(s). The flexible region may include a material which is has a lower hardness than an adjoining portion of the lobe. The flexible region may be less rigid than an adjoining portion of the lobe. For example, the flexible region may be thinner in a direction oblique or perpendicular to the axis of rotation of the lobe than an adjoining portion of the lobe.

A shell differs from a lobe in that a shell is not connected directly to the central body 123, whereas a lobe is connected directly to the central body 123. In FIGS. 3A-3B, 4 & 5A-5B, supports can be seen in which the peripheral bodies 121, 122 are shells. As the handle 100 changes between a low girth state (shown for example in FIG. 3A) and a high girth state (shown for example in FIG. 3B), the peripheral bodies 121, 122 translate obliquely or perpendicularly to the central axis 140 of the handle 100, thereby changing the girth of the support 120. This translation may be linear or it may be curvilinear. The path taken by each shell may be defined by providing regions of the chamber 110 which are more easily deformable than others.

Additionally or alternatively the path taken by each shell may be defined by the manner in which peripheral bodies 121, 122, 131, 132, 133, 161, 162 are arranged around the central axis 140.

In FIGS. 3A-3B the peripheral bodies 121, 122 are shown as undergoing a rotation or even a curvilinear translation, whereby a taper angle α of the handle changes as the handle 100 changes between a low girth state (FIG. 3A) and a high girth state (FIG. 3B). The taper angle α may be measured as the angle between a peripheral body 121, 122, 131, 132, 133, 161, 162 and the central axis 140 of the handle 100, or it may be measured as the angle between two peripheral bodies 121, 122, 131, 132, 133, 161, 162. In this particular case, it is seen that the taper angle α between the peripheral bodies 121, 122 is higher in the high girth state than in the low girth state.

Alternatively, the peripheral bodies 121, 122 may undergo a linear or curvilinear translation, whereby the taper angle between the peripheral bodies 121, 122 in the low girth state to be substantially equivalent to the taper angle between the peripheral bodies 121, 122 in the high girth state.

Alternatively, peripheral bodies 121, 122 may undergo a rotation or even a curvilinear translation, whereby the taper angle between the peripheral bodies 121, 122 in the low girth state is higher than in the high girth state.

The type of movement of the peripheral bodies 121, 122 (i.e. rotation, linear translation, and curvilinear translation) may be determined by the geometry of the chamber 110. For example, a chamber 110 which has a girth that does not vary as a function of position along the central axis 140 may cause a linear translation. For example, a chamber 110 which has a girth that varies as a function of position along the central axis 140, and/or which expands/contracts to varying degrees as a function of position along the central axis 140 may cause a rotation or even a curvilinear translation.

A shell-type peripheral body 121, 122 as shown in the examples of FIG. 3A, 3B or 4 may be fixed to a surface of the chamber 110, or it may even provide an internal surface of the chamber 110. In either case, the fact that the peripheral body 121, 122 is not directly attached to the central body 123 allows movement of the peripheral body 121, 122 relative to the central body 123. Alternatively, a shell-type peripheral body 121, 122 may be able to move relative to the surface of the chamber 110. In this case, the peripheral body 121, 122 may be attached to the central body 123 by a flexible connection, which allows movement therebetween while stabilizing the peripheral body 121, 122.

Although such a configuration is not shown in the Figures, a support 120 may include a combination one or more shell-type peripheral bodies (numeric references 121, 122 in the examples of FIG. 3A, 3B or 4) with one or more lobe-type peripheral bodies (numeric references 131, 132, 133 in the example of FIG. 1A or 1B). For example, in the example shown in FIG. 4, at least one of the peripheral bodies 121, 122 formed as a shell may be replaced by a peripheral body formed as a lobe substantially as explained in connection with the example of FIG. 1A or 1B, which is connected directly to central body 123.

In FIG. 2, the two peripheral bodies 161, 162 are connected to one another to form a wrap 160. As the girth of the handle 100 increases or decreases, so does the girth of the wrap 160. As such, the wrap 160 deforms and the peripheral bodies 161, 162 move. A component of this movement is in a direction that is oblique or perpendicular to the central axis 140. As the girth of the wrap 160 increases, and the curvature of the wrap 160 around the central axis 140 decreases. Consequently, the peripheral bodies 161, 162 may separate from one another and move away from the central axis 140. As the girth of the wrap 160 decreases, the curvature of the wrap 160 around the central axis 140 increases. Consequently, the peripheral bodies 161, 162 may approach one another and move toward the central axis 140.

A wrap 160 may be connected to the central body 123 by a proximal extremity of the wrap 160. In this case, the peripheral bodies 161, 162 can be considered to be lobes substantially as explained in connection with the examples of FIG. 1A or 1B.

Alternatively, a wrap 160 may be disconnected from the central body 123, as shown in FIG. 2. In this case, the wrap 160 and peripheral bodies 161, 162 are of the shell type.

As seen in FIGS. 2, 3A-3B, 4 & 5A-5B, the handle 100 may include a foot 127. The foot 127 may allow the central axis 140 of the handle 100 to be maintained obliquely or perpendicularly to a substantially horizontal surface without being held by a user. Although it is not shown in the Figures, a foot may also be provided for a handle having one, multiple, or even all of its peripheral bodies formed as lobes.

As seen in FIGS. 3A-3B, the handle 100 may include a gripping feature 170. The gripping feature 170 may be provided on the support 120. The gripping feature 170 may be provided on at least one peripheral body 121, 122, 131, 132, 133, 161, 162.

Alternatively/additionally, a gripping feature 170 may be provided on the central body 123, although such an arrangement is not shown in the Figures. The gripping feature 170 may include one or more projections and/or one or more indentations and/or one or more textured regions, and/or one or more layers of material that offer a higher coefficient of friction against human skin than the first material (i.e. the material of chamber 110) and/or the second material (the material of the support 120).

One example of such a material for the gripping feature 170 may include an elastomer and/or a substance providing good friction when wet. An example of such a substance and/or of an elastomer may be a rubber. In FIGS. 3A-3B, the gripping features 170 are shown as including a layer of rubber arranged on an external surface of peripheral body 121 and/or peripheral body 122. For example, the rubber may be a thermoplastic elastomeric (TPE) material. The rubber may have a hardness of approximately 15-25 Shore A. The gripping feature may include, but are not limited to silicones, natural rubber, butyl rubber, styrene butadiene rubber, polyolefin-based TPEs, styrene butadiene styrene (SBS) TPEs, styrene ethylene butadiene styrene (SEBS) TPEs, polyamide TPEs (such as Pebax), polyester TPEs, or polyurethane TPEs. The gripping feature may include a blend of one or more of these TPEs with other substances. The gripping feature may include a blend of multiple of these TPEs, possibly in combination other substances.

Although FIGS. 3A-3B show handles 100 with exoskeletal and/or hybrid supports 120, a gripping feature 170 may also be provided for a handle 100 having an endoskeletal support 120. For example, the gripping feature 170 may be a portion of an exterior surface of the chamber 110. Alternatively, the gripping feature 170 may be provided on an exterior surface of the chamber 110.

As seen in FIG. 2, the handle 100 may include a port 150. The port 150 may allow the chamber 110 to change in volume. For example, fluid may be introduced into the chamber 110 by way of the port 150 to increase the volume of the chamber 110. For example, fluid may be removed from the chamber 110 by way of the port 150 to decrease the volume of the chamber 110. Removal of fluid from the chamber 110 may include exhausting fluid from the chamber 110, possibly by way of the port 150 (if present).

Although such a configuration is not visible in the Figures, the port 150 may be arranged in other areas of the handle 100. For example, the port 150 may be arranged in the central body 123 of the support 120, or in a peripheral body 121, 122, 131, 132, 133, 161, 162 of the support 120, or even may be arranged in an exposed exterior surface of the chamber 110. Any of these arrangements would be suitable for use with the support 120 shown in FIGS. 1A-1B.

Although not shown in the Figures, the handle 100 may include a button. The button may be connected to a valve, such that operation of the button (such as by pressing, contacting, releasing, etc.) leads to a change of state of the valve. For example, operation of the button may allow a user to open and/or close the valve, and/or assume a partially-open (partially-closed) position. At least a part of the valve may be located within the chamber 110. Additionally or alternatively, at least a part of the valve may be located outside of the chamber 110. As a non-limiting example, the button may allow a user open and/or close and/or partially open (partially close) the port 150, so that fluid may pass therethrough.

As seen in FIGS. 3A-3C, the handle 100 may be fluidly connectable to a stand 220 (see FIG. 3B). The handle 100 may be disconnectable from the stand220 (See FIGS. 3A & 3C). The handle 100 may even be removably connectable to the stand 220. In this way, a user may be able to connect, and subsequently disconnect the handle 100 and the stand 220 to each other, and/or may be able to disconnect, and subsequently reconnect the handle 100 and the stand 220 to each other. The handle 100 may be connected to the stand 220 by the port 150. As such, the port 150 may be connectable, disconnectable, or even removably connectable to the stand 220.

To that end, the port 150 may be provided in a bearing surface 126, as seen in FIGS. 2, 3A-3B, 4 & 5A-5B. As can be seen in FIG. 3B, the bearing surface 126 may facilitate cooperation of the stand 220 and the handle 100 by aiding in proper alignment and connection therebetween. Provision of the port 150 in a bearing surface 126 may likewise be compatible with a handle 100 having one, multiple, or all of its peripheral bodies formed as lobes. As such, a port 150 arranged on a bearing surface 126 may also be compatible with the support 120 shown in FIGS. 1A-1B. The bearing surface 126 may be provided on a foot 127 of the handle 100. The bearing surface 126 may be an integral part of the foot 127 (as seen in FIGS. 3A-3B) or the bearing surface 126 may be provided on a separate component 126a that forms part of a foot assembly 127 with at least one other component 127a (as seen in FIG. 4).

Although FIGS. 2, 3A-3B, 4 & 5A-5B show a foot 127 being used with supports 120 having shell-type peripheral bodies 121, 122 and/or wrap-type peripheral bodies 161, 162, a foot 127 may also be used with supports 120 having one, multiple, or even all of their peripheral bodies formed as lobes 131, 132, 133, such as the support 120 shown in FIGS. 1A-1B.

As mentioned earlier herein, the support 120 shown in FIGS. 1A-1B may be suitable for an endoskeletal arrangement or an exoskeletal arrangement. An endoskeletal arrangement may take many forms. For example, a simple chamber 110 may be arranged around the lobes 131, 132, 133 of the support 120, and an opening in chamber 110 may be sealed to the central body 123 of the support 120 by any suitable technique, including those described above. Alternatively, a lobe 131, 132, 133 may be inserted in its own chamber 110 (or branch of a chamber 110). Such arrangements may also be compatible with wrap-type 161, 162 and/or shell-type 121, 122 peripheral bodies.

Independently of whether the handle 100 features an endoskeletal arrangement, an exoskeletal arrangement, or a hybrid arrangement, a branched chamber 110 may be provided such that each branch 110 corresponds to a peripheral body 121, 122, 131, 132, 133, 161, 162. For example, in FIGS. 3A-3B, branch 110a is provided on shell 121, and branch 110b is provided on shell 122. This correspondence may also be provided in the case of one or more peripheral bodies formed as lobes 131, 132, 133, and/or one or more peripheral bodies 161, 162 formed as a wrap 160.

The pump 200 may allow fluid to be delivered to the handle 100 and/or extracted from the handle 100. If a port 150 is present in the handle 100, fluid delivered by the pump 200 may be introduced into the chamber 110 by way of the port 150, and/or fluid extracted by the pump 200 may be removed from the chamber 110 by way of the port 150. Extraction of fluid by pump 200 may be possible without regard for whether passive exhaustion of fluid from the chamber 110 is possible.

The stand 220 may include a nozzle 210 connected to a pump to facilitate delivery fluid to the handle 100 and/or extraction fluid from the handle 100. The nozzle 210 may be connectable, disconnectable, or even removably connectable to the handle 100. If a port 150 is present in the handle 100, the nozzle 210 may cooperate with the port 150. In this way, fluid delivered to the handle 100 and/or extracted from the handle 100 by the pump 200 through the nozzle 210 may be introduced into the chamber 110 and/or removed from the chamber 110 by way of the port 150. Non-limiting examples of cooperation between the nozzle 210 and the port 150 include connectability, disconnectability and removable connectability. Cooperation between the nozzle 210 and the port 150 may be penetrative or non-penetrative.

As seen in FIGS. 3B-3C, the stand 220 may include a pump 200. The stand 220 may be configured to support the handle 100, as seen in FIG. 3B. Such a configuration may allow the handle 100 to be maintained in an upright position (relative to the stand 220). For example, when the nozzle 210 is provided in the stand 220, then connecting the port 150 to the nozzle 210 may also cause the handle 100 to be maintained in this upright position. A non-limiting example of such a configuration may be seen in FIGS. 3A-3C, wherein it may be understood (at least for the purposes of this paragraph) that the port 150 is provided in bearing surface 126 of foot 127. Thus, the nozzle 210 may contribute to positioning the handle 100 in the stand 220.

The stand 220 and the handle 100 may each be provided with corresponding surfaces that cooperate to curtail inadvertent disconnection of the port 150 and the nozzle 210 during introduction of fluid into the chamber 110 and/or removal of fluid from the chamber 110.

Moreover, as can be seen in FIG. 3B, the stand 220 may even be able to support the handle 100 even when at least one attachment is attached to the handle 100. For the purposes of the present disclosure, the term “attachment” can be understood to mean a component of a device including the handle 100, other than the handle 100 itself. As a non-limiting example, in the context of a shaver, a shaver head 310 may be considered an attachment.

The handle 100 may be suitable for a device. The device may include an attachment and the handle 100. The device may be a handheld device. The handheld device may be a skincare device 300 as seen in FIGS. 3A-3C, 4 & 5A-5B. The skincare device 300 may include one or more blades. The one or more blades may be for cutting hair. As such, the skincare device 300 may be a shaver.

The adjustable girth of the handle 100 may improve ergonomics of use of the device, and/or may facilitate safe and/or comfortable manipulation of the handle 100 and maneuvering of any attachment borne thereon.

In the context of a skincare device 300, the improvements in ergonomics may allow a user to care for skin in a manner that is more comfortable and/or safer and/or more effective than may be possible for a handle that is ergonomically maladapted to the user's hand.

Moreover, and independently of the context of skincare, the adjustable girth of the handle 100 may allow the benefits of the handle 100 to be conferred to multiple hands of different sizes (as can happen if the handle is shared between users) with a single handle 100. This provides for a more versatile skin care device, as the same handle may fit different hand sizes, thus allowing the same handle to be marketed to a wider range of potential users than a single handle of fixed girth.

In the handle 100 as described earlier herein, the central body 123 provides an attaching location for a device's attachments. Thus, in the skincare devices 300 shown in FIGS. 3A-3B, 4 & 5A-5B, the attachment, shaver head 310, is attached to the central body 123 of the support 120. This connection may either be direct (as shown in FIGS. 3A-3B, 4 & 5A-5B), or the handle 100 may be connected to the shaver head via a connector portion provided on the central body 123. Connector portions are well known for a skilled person and may be found e.g. in WO9836878, which is incorporated herein in its entirety, including from page 4, line 21 to page 9, line 32 (notably lines 20-22 and 29-31 of page 5, lines 2-4 of page 6, and from page 7, line 11 to page 9, line 32), as well as FIGS. 1-17. The connector portion may include an ejection mechanism for facilitating disconnection of the attachment from the handle 100.

When the handle 100 is connected to the attachment directly, the handle may include a coupling mechanism for connecting to the attachment. Coupling mechanism are also well known and may be found e.g. WO2015158382, which is incorporated herein in its entirety, including from page 6, line 23 to page 26, line 2 (notably lines 23-25 of page 6, from line 35 of page 6 to line 8 of page 8, from line 9 of page 11 to line 3 of page 12, and from line 10 of page 13 to line 2 of page 26) as well as FIGS. 1A-1B, 2, 3A-3F, 4A-4D, 5A-5B & 6-8. The coupling mechanism may include an ejection apparatus for facilitating disconnection of the attachment from the handle 100.

Forces applied by the user to an exterior surface of the handle 100 may be transmitted to the central body 123 of the support 120. If an attachment is connected to the handle 100, the central body 123 may transmit forces from the handle 100 to the attachment. As such, a user may be able to maneuver the attachment by manipulating the handle 100.

In the skincare device 300 shown in FIG. 4, the central body 123 may cooperate with the frame 124 to stabilize the shaver head 310.

The stand 220 and/or the handle 100 and/or a device including the handle may form part of a kit. The kit may include a control panel. The control panel may be configured to select an operating parameter for the pump 200. This operating parameter may include an on-off condition for the pump 200. The on-off condition may include or be a shutoff condition for the pump 200. Non-limiting examples of operating parameters for the pump include fluid flow rate and/or fluid pressure and/or fluid quantity. For example, the pump 200 may be configured to modify the pressure and/or volume of the chamber 110 by delivering or extracting fluid until the fluid within the chamber 110 reaches a certain pressure and/or until the chamber 110 contains a certain volume of fluid, and/or until the pump 200 has introduced/removed a certain volume of fluid from the handle 100.

The control panel may be provided on the stand 220 (if present in the kit) and/or on the handle 100 (if present in the kit) and/or on a device including the handle 100 (if present in the kit). Additionally or alternatively, the control panel may be provided on an additional device, for example in the form of a software user interface. Additionally, having such a versatile handle forming part of a kit provides for multiple interrelated actions to be taken using the same handle, e.g. exfoliation or shaving can be done using the same handle if the shaving cartridge is replaced with an exfoliation head. This provides for adaptability of the handle in between these two actions, e.g. if for one of the actions the user prefers a smaller/bigger handle girth size than for the other. Alternatively, it allows for different users, e.g. male/female, to have their own cartridge and share the same handle.

The control panel may be configured to prevent excessive introduction of fluid into the chamber 110 and/or excessive removal of fluid from the chamber 110. As a non-limiting example, the control panel may accomplish this function based on readings of a sensor configured to measure the fluid. As a non-limiting example, the control panel may drive the pump 200 until the sensor indicates that additional fluid introduction or removal would become excessive. At this point, for example, the control panel may stop driving the pump 200. For example, excessive fluid introduction or removal may lead to the handle 100 having a girth that is different than is desired by a user. For example, excessive removal of fluid may cause the handle 100 to have a girth that is less than is desired by the user. For example, excessive introduction of fluid may cause the handle 100 to have a girth that is greater than is desired by the user. To prevent such problems, the sensor may be configured to measure volumetric flow. A user may be able to specify a pressure of fluid in the chamber 110 and/or a volume of fluid introduced into/removed from/contained in the chamber 110, and/or a girth of the handle 100.

Excessive fluid introduction or removal may also cause damage to the handle 100 (for example a burst chamber 110) and/or pump 200 (for example a worn out pump 200), and/or disconnection of the pump 200 and the handle 100 when such disconnection is not desired or performed by a user, and/or difficulty for a user to disconnect the pump 200 from the handle 100 when such disconnection is desired. To avoid such problems, the sensor may include a pressure sensor.

The control panel may be configured to prevent a user from selecting a pressure and/or volume of the chamber 110 and/or a girth of the handle 100 that would necessitate the pump 200 running until one or more of these scenarios was generated.

As non-limiting examples, returning to FIGS. 2 & 4, it can be seen a simple chamber 110 may be balloon-like, insofar as it includes a single opening (FIG. 2) or tube-like, insofar as it includes multiple openings (FIG. 4). In the case of a branched chamber 110, as seen in FIGS. 3A-3B, each branch of the chamber 110 may, as non-limiting examples, be balloon-like, insofar as the branch would include a single opening if disconnected from the remainder of the chamber 110, or tube-like, insofar as the branch would include multiple opening if disconnected from the remainder of the chamber 110. Moreover, a given branched chamber 110 may have at least one branch which is balloon-like and at least one branch which is tube-like.

The presence of at least one opening in the chamber 110 (such as may be provided by a port 150) may allow fluid to move into or out of the chamber 110 as needed to change the girth of the handle 100. However, to maintain a given girth, it may be desirable to prevent this movement (at least intermittently). To that end, the opening may be sealed.

A port 150 may contribute to sealing such an opening, or may even be entirely responsible for sealing the opening.

All variants of the support 120 described herein may be compatible with use of a port 150, and this port 150 may even be used to seal an opening in the chamber 110 of the handle 100 in which the support 120 is provided.

Additionally or alternatively, an opening in the chamber 110 may be sealed using other techniques. For example, an opening in the chamber 110 may be sealed by fixing the opening to another component of the handle 100. Non-limiting techniques for fixing a chamber 110 to another component of a handle 100 include (but are not limited to) gluing the chamber 110 to the component, and/or over-molding the chamber 110 on the component (or over-molding the component on the chamber), and/or injection molding and/or blow molding of the chamber 110 and/or of the component.

Non-limiting examples of components of the handle 100 which are suitable for sealing of an opening in the chamber 110 by fixation of the chamber 110 thereto can be seen in the figures.

According to aspects, the foot 127 may contribute to sealing an opening in the chamber 110. For example, in FIGS. 2 & 5A-5B, a foot 127 may be fixed to an opening in the chamber 110 using any suitable technique, including those presented earlier herein, to seal the opening.

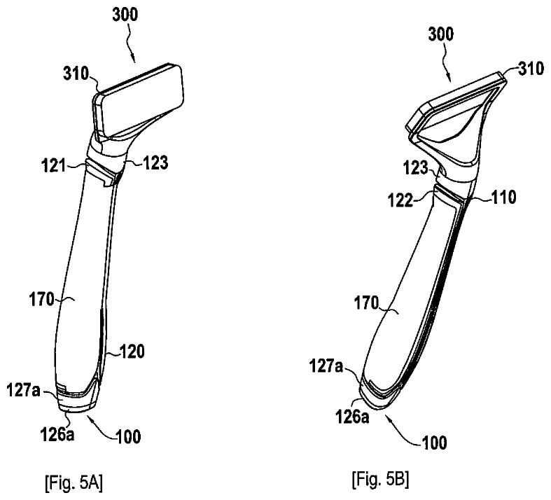

The foot 127 may be monolithic, as shown in FIG. 2, or it may even be a foot assembly, as shown in FIGS. 5A-5B. In the case of a foot assembly, the chamber 110 may be sandwiched between the components 126A, 127A of the foot assembly 127 to provide the sealing. Sandwiching of the chamber 110 between the components 126A, 127A of the foot assembly 127 may be achieved using any suitable technique, including those presented earlier herein.

The foot 127 may contribute to sealing an opening of the chamber 110 on its own, or the foot 127 may cooperate with another element of the handle 110, such as the support 120, to contribute to sealing an opening in the chamber 110. For example, in FIG. 4, the foot 127 may cooperate with the frame 124 of the support 120 to contribute to sealing an opening in the chamber 110. In such a configuration, the chamber 110 may be sandwiched between the foot 127 and the frame 124. Although FIG. 4 shows a foot assembly 127, such a configuration is also possible with a monolithic foot 127, such as those shown in FIGS. 2 & 3A-3B. If the foot 127 is a foot assembly, as shown in FIG. 4, the chamber 110 may be sandwiched between the frame 124 and one of the foot assembly's components 126A, 127A, or even between the frame 124 and some or even all of the foot assembly's components 126A, 127A. Sandwiching of the chamber 110 between the frame 124 and the foot 127 (or between the frame 127 and one or more foot components 126A 127A) may be achieved using any suitable technique, including those presented earlier herein.

The support 120 may also contribute to sealing an opening of the chamber 110 on its own (i.e. without cooperating with another element of the handle 110). For example, in FIG. 4, the frame 124 of the support 120 and the central body 123 of the support 120 may cooperate to contribute to sealing an opening in the chamber 110 on their own. In such a configuration, the chamber 110 may be sandwiched between the central body 123 and the frame 124 to provide sealing. Sandwiching of the chamber 110 between the frame 124 of the support 120 and the central body 123 of the support 120 may be achieved using any suitable technique, including those presented earlier herein. Moreover, the frame 124 of the support 120 may contribute to sealing an opening in the chamber 110 on its own (i.e. without cooperating with another element of the support 120 or the handle 110). For example, instead of being sandwiched between the central body 123 and the frame 124, chamber 110 may simply be sealed against a portion of frame 124 using any suitable technique, including those presented earlier herein.

Likewise, the central body 123 of the support 120 may contribute to sealing an opening in the chamber 110 on its own (i.e. without cooperating with another element of the support 120 or the handle 110). For example, instead of being sandwiched between the central body 123 and the frame 124, the chamber 110 may simply be sealed against a portion of the central body 123 using any suitable technique, including those presented earlier herein. This portion of the central body 123 may be an interior surface of the central body 123. On the other hand, in FIGS. 1A-1B, for example, the central body 123 of the frame 120 may contribute to sealing an opening in a chamber 110 on its own by fixing the opening of the chamber 110 around an external surface of the central body 123.

A peripheral body 121, 122, 131, 132, 133, 161, 162 may also contribute to sealing an opening in a chamber 110. For example, the opening may be fixed around a peripheral body. For example, a lobe 131, 132, 133 may be inserted into an opening in the chamber 110 and the opening fixed therearound using any suitable technique, including those presented earlier herein, to seal the opening. A similar technique may be used for a wrap-type peripheral body 161, 162 or a shell-type peripheral body 121, 122.

When a port 150 is provided for any of these openings, the port 150 may be provided independently of the chamber 110, and arranged in a hole provided in the component of the handle 100 against which the opening is sealed. Non-limiting examples of such holes can be seen in the foot 127 of FIG. 2 and the foot 127 of FIG. 4.

Alternatively, a port 150 may seal an opening in the chamber 110 on its own (i.e. without cooperating with other elements of the handle 100). For example, the port 150 may be provided in the chamber 110 itself. In such a configuration, the chamber 110 may be arranged in the handle 100 such that the port 150 is arranged in a hole provided in one of the other components of the handle 100. Although such holes may be seen in the foot 127 of FIG. 2 and the foot 127 of FIG. 4, the hole may be provided in any other component of the handle 100 in contact with the chamber 110.

Although sealing an opening in the chamber 110 with another component of the handle 100 may have the effect of fixing the chamber 110 thereto, it is also possible to fix the chamber 110 to another component of the handle 100 without sealing an opening in the chamber 110. In other words, all of the techniques described herein for sealing an opening in the chamber 110 to another component of the handle 100 may also be suitable for simply fixing the chamber 110 to the component of the handle 100.

For example, in FIGS. 1A-1B, a balloon-like chamber 110 may be arranged between the lobes 131, 132, 133 of the support 120, with an opening in the chamber 110 arranged away from the proximal extremities of the lobes 131, 132, 133. The balloon-like chamber 110 may be stabilized relative to the support 120 by being fixed to an internal portion of the central body 123 using any suitable technique, including those described earlier herein with regard to sealing, even though no opening is present in the balloon-like chamber 110 where it is connected to the central body 123. Similarly, in FIG. 2, a balloon-like chamber 110 may be fixed to the central body 123, and have its opening sealed by a port 150 arranged in the foot 127, or else sealed by the foot 127 itself, with a separate port 150 arranged in the foot 127.

The measures taken to seal an opening in the chamber 110 may also allow for local stabilization of the chamber 110 within the handle 100. As such, a tube-like chamber 110, or a tube-like branch of a chamber 110 may be stabilized at multiple locations simply by being sealed. In contrast, with a balloon-like chamber 110, or a balloon-like branch of a chamber 110, it may be desirable to provide additional fixation beyond that which may be provided simply by sealing. For example, the chamber 110 of the handle 100 shown in FIG. 2 may be fixed to the central body 123 by any suitable method. Each of the methods laid out earlier regarding methods of sealing the chamber 110 on the foot 127 may also be suitable for fixing the chamber 110 to the central body 123.

Additionally or alternatively, any of these techniques may be used to fix the chamber 110 to one or more of the peripheral bodies 121, 122 of the support 120, independently of whether the chamber 110 presents an opening to be sealed at the site of fixation. Moreover, any of these techniques may also be suitable for fixing the chamber 110 to one or more of the peripheral bodies of a support 120 having one or more lobe-type peripheral bodies 131, 132, 133 and/or one or more wrap-type peripheral bodies 161, 162.

The chamber 110 may be fixed and/or sealed one or more on surfaces of the support 120 which are arranged to face the chamber 110. As non-limiting examples, these surfaces may be provided by the central body 123, by a peripheral body, 121, 122, 131, 132, 133, 161, 162, or other elements of the handle 100. Alternatively or additionally, chamber 110 may even be fixed and/or sealed on one or more edges of the support 120, such as the peripheral edge of a peripheral body 121, 122, 161, 162.

For example, in FIGS. 1A-1B a simple, balloon-like chamber 110 may be fixed to the support 120 such that its opening is arranged substantially away from the central body 123. This may be achieved through any suitable technique, including one or more of those presented earlier herein. Therefore, the fixation point may be found in the interior of the support 123. Additionally or alternatively, the chamber 110 may be secured to one or more surfaces of one or more peripheral bodies 131, 133, 132 facing the chamber 110.

Similarly, in FIG. 2, for example, a simple, balloon-like chamber 110 may be fixed to an interior surface of the central body 123 and to the foot 127 of the handle 110. In such a configuration the chamber 110 may for example be fixed to an interior surface of the peripheral body 160 formed as a wrap in order to prevent it from rotating relative to the chamber 110. A branched and/or tube-like chamber 110 may be fixed to the support 120 in a similar manner. Moreover, if the chamber 110 is branched, each branch thereof may be fixed to the support 120 in a different manner from each other.

The foregoing discussion relating to fixation of a chamber 110 and/or sealing of an opening in a chamber 110 is applicable whether the chamber 110 is simple or branched. In the case of a branched chamber 110, the foregoing discussion may apply to each branch of the chamber 110 individually or even to a portion of the chamber 110 connected to multiple branches thereof.

Although the described embodiments were provided as different exemplary embodiments, it is envisioned that these embodiments are combinable or, when not conflicting, the features recited in the described embodiments may be interchangeable. Moreover, the features recited in the described embodiments are not inextricably linked to one another, unless such a linkage is clearly indicated between two given features.

Throughout the description, including the claims, the term “comprising a” should be understood as being synonymous with “comprising at least one” unless otherwise stated. The same applies for “including a” with regard to “including at least one”. In addition, any range set forth in the description, including the claims should be understood as including its end value(s) unless otherwise stated. Specific values for described elements should be understood to be within accepted manufacturing or industry tolerances known to one of skill in the art, and any use of the terms “substantially” and/or “approximately” and/or “generally” should be understood to mean falling within such accepted tolerances.

Although the present disclosure herein has been described with reference to particular embodiments, it is to be understood that these embodiments are merely illustrative of the principles and applications of the present disclosure.

It is intended that the specification and examples be considered as exemplary only, with a true scope of the disclosure being indicated by the following claims.

1. A handle for a skincare device, the handle comprising an inflatable chamber, the handle being configured to pass from a first state to a second state in response to a volumetric change of the chamber, wherein a volume and/or a girth of the handle in the second state is greater than a volume and/or a girth of the handle in the first state, the handle further comprising a support connected to the chamber wherein the support is arranged on two or more external portions of the chamber.

2. The handle according to claim 1, wherein the chamber includes a first material and the support includes a second material, the second material having a hardness greater than a hardness of the first material.

3. The handle according to claim 1, wherein the support comprises a central body and two or more peripheral bodies, the two or more peripheral bodies being moveable relative to the central body.

4. The handle according to claim 3, wherein the two or more peripheral bodies support a gripping feature.

5. The handle according to claim 3, wherein at least one of the two or more peripheral bodies is formed as a lobe, wherein the lobe has a proximal end connected to the central body.

6. The handle according to claim 3, wherein at least one of the two or more peripheral bodies is formed as a shell separated from the central body.

7. The handle according to any claim 3, wherein at least two or more of the peripheral bodies are connected to one another to form a wrap.

8. The handle according to claim 1, at least a portion of the handle being configured to expand from the first state to the second state in a direction oblique or perpendicular to a longitudinal axis of the handle.

9. The handle according to claim 8, wherein the longitudinal axis is running along a length of the handle and is curvilinear.

10. The handle according to claim 1, comprising a port for changing a volume of the chamber.

11. The handle according to claim 10, wherein the port is removably connectable to a stand.

12. The handle according to claim 10, wherein the port is provided in a bearing surface, wherein the bearing surface facilitates cooperation of the stand and the handle by aiding in proper alignment and connection therebetween.

13. A skincare kit comprising a stand which further comprises a pump, a handle according to claim 1, and a control panel configured to select an on-off condition for the pump.

14. The skincare kit according to claim 13, wherein the stand further comprises a nozzle connected to the pump and being adapted to at least partially inflate and/or at least partially deflate the chamber.

15. A handheld skincare device comprising a handle according to claim 1 and one or more blades for cutting hair.
